(19) United States
(12) Patent Application Publication
(10) Pub. No.: US 2016/0096184 A1
(43) Pub. Date: Apr. 7, 2016

(54) ROTATABLE SPRAY HEAD, MULTI-MATERIAL SPRAYING APPARATUS USING THEREOF, AND METHOD FOR SPRAYING MULTIPLE MATERIALS

(71) Applicant: Zong Jing Investment, Inc., Taipei (TW)

(72) Inventors: Charlene Hsueh-Ling Wong, Taipei (TW); John Chen, Taipei (TW)

(21) Appl. No.: 14/697,833

(22) Filed: Apr. 28, 2015

(30) Foreign Application Priority Data
Oct. 1, 2014 (TW) 103134320

(51) Int. Cl. B05B 3/10; B05B 7/24

(52) U.S. Cl. CPC B05B 3/1035; B05B 7/2491

(57) ABSTRACT

A rotatable spray head, a multi-material spraying apparatus using the rotatable spray head, and a method of spraying multiple materials are provided. The multi-material spraying apparatus includes the rotatable spray head. The rotatable spray head includes an outer shell and an inner shaft tube, for creating relative rotational motion between each other to switch the spraying material. Different materials can be sprayed one at a time through a same ejecting outlet of the rotatable spray head. A recycling step of the method allows the sprayed material to be recycled back to a material supplying pipe or a material holder, before switching to a different spraying material, in order to prevent the mixing of different spraying materials.

### CROSS-REFERENCES TO RELATED APPLICATIONS

This non-provisional application claims priority under 35 U.S.C. §119(a) on Patent Application No. 103134320 filed in Taiwan, R.O.C. on Oct. 1, 2014, the entire contents of which are hereby incorporated by reference.

### BACKGROUND

1. Technical Field

The instant disclosure relates to a rotatable spray head, a multi-material spraying apparatus using thereof, and a method for spraying multiple materials. In particular, the instant disclosure relates to a rotatable spray head, a multi-material spraying apparatus using thereof, and a method for spraying multiple materials applicable for different kinds of spraying machines.

2. Related Art

It is human nature to strive for beauty. Consequently, numerous cosmetics for customers have appeared. Nevertheless, in order to apply proper facial makeup or eye makeup, the user must practice the makeup skills repeatedly. Furthermore, drawing various eyebrow shapes, eye contours, eye lines, and eye shadows, etc., requires the purchase of many kinds of cosmetics and makeup tools. However, the difference in proficiency in the technique of applying makeup and the wide range of cosmetics usually result in a difference between the effect of the makeup and the effect expected by the user.

In addition, it is not easy for the user to satisfactorily apply makeup on a consistent basis, due to different cosmetics to be used, different makeup tools, different locations in which to apply makeup, or the proficiency in applying cosmetics. Furthermore, the user has to spend a lot of time to practice the makeup skills if he/she is unfamiliar with the process. Therefore, the user may not be able to apply makeup in a timely manner or with satisfaction.

As a result, several automatic makeup machines have been recently developed and are available to be sold. Accordingly, after the user has chosen the desired makeup, the makeup machine operates based on a program to provide the makeup effect for the user. In addition, since the work of applying makeup is done by a machine, the makeup effect can be produced with repetition. Nevertheless, the makeup machine is a combination of various elements. One of the main elements is the makeup device that puts the makeup on the user.

Several makeup methods are available for applying makeup materials to a user's face. For example, a robot arm is adapted to pick out the desired cosmetic and apply the cosmetic to the face of the user. Another approach is utilizing a spraying device to spray the makeup materials on the face of the user with precise control. However, with the spraying technique, how to spray multiple makeup materials becomes an issue. To simplify the structure of the makeup spraying device, the makeup spraying device preferably contains one spray head and has replaceable material holders. Accordingly, the user can apply the makeup easily by replacing the makeup materials in the material holders and does not need to buy many makeup devices.

However, it is still important to address the issue of how to allow the makeup materials in different material holders to be sprayed via the same spray head and how to choose the makeup material to be sprayed. Moreover, when all the makeup materials are sprayed via the same spray head, the makeup materials would mix with each other. For instance, if some of first makeup materials are left in the spray head, the next time when the user switches to second makeup materials for putting makeup on his/her face, the first makeup materials would mix with the second makeup materials, so that the color of the makeup sprayed out of the spray head is mixed and not expected by the user, therefore the makeup effect cannot be produced properly.

### SUMMARY

To address the above-mentioned issues, the instant disclosure provides a rotatable spray head comprising an outer shell and an inner shaft tube. The outer shell defines a receiving cavity, an ejecting outlet and at least two radial inlets. The receiving cavity communicates with the ejecting outlet, and each of the radial inlets radially communicates with the receiving cavity. With respect to the outer shell, the inner shaft tube is coaxially received in the receiving cavity. The inner shaft tube defines a central channel and a lateral through hole. One of the two openings of the central channel communicates with the ejecting outlet of the outer shell, and the other opening of the central channel is a gas inlet. The lateral through hole is defined on the inner shaft tube to communicate with the central channel. The inner shaft tube is rotatable relative to the outer shell, and the lateral through hole selectively communicates with one of the radial inlets.

Accordingly, the materials placed in different material holders can be delivered into the central channel of the inner shaft tube of the rotatable spray head via different radial inlets and then ejected via the ejecting outlet of the outer shell. When the user wants to change the material to be sprayed, the inner shaft tube is rotated relative to the outer shell until the lateral through hole is aligned to and communicates with the radial inlet of the targeted material. Based on this, different materials can be sprayed from the same ejecting outlet.

Furthermore, the outer shell and the inner shaft tube can be made of Teflon or other materials performing proper non-stick characteristic. During material spraying, the material is first delivered into the lateral through hole of the inner shaft tube from one of the radial inlets of the outer shell, and then the material is delivered through the central channel and ejected from the ejecting outlet of the outer shell. Therefore, the material passes through the outer shell and the inner shaft tube during material spraying. To prevent the material from adhering to the surface of the outer shell or the inner shaft tube and to solve the material mixing problem, the outer shell and the inner shaft tube are preferably made of Teflon. Due to the non-stick characteristic of Teflon, materials will generally not adhere to a Teflon-made or Teflon-coated surface, and the material mixing problem can be solved properly. Furthermore, the Teflon-made outer shell and inner shaft tube would have lower surface frictions, such that the inner shaft tube can be rotated relative to the outer shell easily. Namely, when the outer shell and the inner shaft tube are made of Teflon, a small power source is enough to drive the outer shell or the inner shaft tube to generate the rotational motion.

A motor and a speed reduction gear assembly are provided as the power source for driving the outer shell to rotate relative to the inner shaft tube or for driving the inner shaft tube to rotate relative to the outer shell. The speed reduction gear assembly is connected between the motor and the inner shaft tube. The motor drives the inner shaft tube to rotate via the speed reduction gear assembly. Alternatively, the speed reduction gear assembly can be connected between the motor and the outer shell, such that the motor drives the outer shell to rotate via the speed reduction gear assembly. That is to say, the power source drives the outer shell or the inner shaft tube to rotate, in order to allow communication between the lateral through hole of the inner shaft tube and the radial inlet that corresponds to the desired makeup material.

Furthermore, two O-rings are fitted on the inner shaft tube. The lateral through hole is formed on a protruded portion of the inner shaft tube, and the two O-rings sandwich the protruded portion along an axial direction of the inner shaft tube. Accordingly, the low-viscosity material is prone to enter the receiving cavity of the outer shell from the gap between the radial inlet and the lateral through hole when the material is delivered to the lateral through hole. Therefore, the material would stick to the surface of the outer shell and the surface of the inner shaft tube. In that case, it becomes harder to create relative rotational motion between the outer shell and the inner shaft tube, because after the rotatable spray head has been used for a prolonged period of time, the solidified material between the inner shaft tube and the outer shell increases the rotational friction. In addition, cleaning can be carried out only by disassembling the whole rotatable spray head, which is very inconvenient. In response, the two O-rings are provided to specifically sandwich the protruded portion where the lateral through hole is defined, such that the material flowing into the receiving cavity of the outer shell from the gap between the radial inlet and the lateral through hole can be stopped at opposite sides of the protruded portion by the blocking effect of the O-rings. As a result, the rotational friction between the outer shell and the inner shaft tube can be reduced due to fewer materials sticking to the outer shell and the inner shaft tube. Also, the rotatable spray head can be cleaned much easier due to fewer residual materials.

Moreover, the inner wall of the receiving cavity of the outer shell further has a neck segment, and the radial inlets are defined at the neck segment. The neck segment creates space to accommodate the O-rings such that the neck segment is sandwiched therebetween. The neck segment allows the lateral through hole and the selected radial inlet to mate more firmly with each other.

The radial inlets of the rotatable spray head can be spaced in an equiangular manner around the longitudinal axis of the outer shell, such that the rotating angle of the rotatable spray head can be set more easily. However, the radial inlets may also be spaced in a non-equiangular manner. For instance, when two radial inlets are defined on the outer shell, the radial inlets may be bunched with minimal spacing therebetween so that a rotation of small angle is all that is needed to make the material switch. There is no need to rotate 180 degrees to switch to a different material.

Furthermore, the rotatable spray head comprises a press plate fastened to the outer shell and abutted against the inner shaft tube. The outer shell cannot be secured with the inner shaft tube directly, because the inner shaft tube and the outer shell still need to create relative rotational motion therebetween. Yet, the inner shaft tube has to be received in the receiving cavity of the outer shell. Therefore, the abutment of the press plate allows the inner shaft tube to be held in the receiving cavity of the outer shell, even during the spraying of material.

The inner wall of the receiving cavity of the outer shell further has a female thread, and the outer shell further includes a nozzle. The nozzle is formed with the ejecting outlet and a male thread. The male thread is engaged with the female thread, so that the nozzle is secured in the receiving cavity of the outer shell. Since the nozzle is screwed to the outer shell for securement, the nozzle can be easily disengaged for replacement after extended use or according to different spraying requirements.

Furthermore, the inner shaft tube includes an inserting tip adapted to the gas inlet of the central channel. The inserting tip may have a tapered segment extending toward the gas inlet, after the inserting tip is inserted into the inner shaft tube. When the motive gas necessary for material spraying is to be entered into the central channel, a gas supplying pipe can be connected to the inserting tip. The gas supplying pipe can be easily lined up with the inserting tip via the tapered segment. Furthermore, the tapered segment can slightly expand the opening of the gas supplying pipe, so that the inserting tip and the gas supplying pipe can be more firmly engaged to each other. Based on this, the gas supplying pipe would not easily detach from the inserting tip under the influence of backward counterforce produced when supplying the motive gas.

The instant disclosure further provides a multi-material spraying apparatus comprising a rotatable spray head, at least two material holders, and a gas supplying device. The rotatable spray head includes an outer shell and an inner shaft tube. The outer shell defines a receiving cavity, an ejecting outlet, and at least two radial inlets. The receiving cavity communicates with the ejecting outlet, and each of the radial inlets radially communicates with the receiving cavity. With respect to the outer shell, the inner shaft tube is coaxially received in the receiving cavity. The inner shaft tube defines a central channel and a lateral through hole. One of the two openings of the central channel communicates with the ejecting outlet of the outer shell, and the other opening of the central channel is a gas inlet. The lateral through hole is defined on the inner shaft tube to communicate with the central channel. The inner shaft tube is rotatable relative to the outer shell, and the lateral through hole can selectively communicate with one of the radial inlets. A material supplying pipe is extended from each of the material holders to communicate with the corresponding radial inlet of the outer shell. The gas supplying device comprises a gas supplying pipe communicating with the gas inlet of the inner shaft tube. An electromagnetic valve is connected to the gas supplying pipe to control the supply of motive gas to the gas inlet.

When the user wants to use the multi-material spraying apparatus to spray material (for example, for putting on makeup or for painting), the rotatable spray head is further connected to the material holders and the gas supplying device. At least two or more material holders may be adjusted to set according to user requirements. Each of the material holders is connected to one material supplying pipe to communicate with the outer shell, such that each type of material is delivered to the rotatable spray head via the corresponding radial inlet and ejected through the ejecting outlet. The gas supplying device provides the motive gas, where the material from the material holder is pushed by the motive gas to move toward the ejecting outlet and the material can be further ejected and sprayed to the object through enough power. Thereby, the material can be sprayed over the object uniformly, without the need to have the rotatable spray head in contact with the object.

Moreover, the replacement of the material holder can be carried out easily since the material holder is not in the rotatable spray head but communicates with the outer shell via the material supplying pipe. Furthermore, the type of the material holder is not limited. Here, the material holder is replaceable, and the user can feed the material holder with a target material or just buy a material holder containing the target material when the target material is exhausted. Alternatively, any market available materials can be passed through the material supplying pipe to be delivered to the rotatable spray head.

When the user wants to change the material to be sprayed from a first material to a second material, a relative rotational motion between the inner shaft tube and the outer shell is all that is needed, such that the lateral through hole of the inner shaft tube communicates with the radial inlet corresponding to the second material. Accordingly, different materials can be sprayed from the same ejecting outlet. Moreover, the material does not spill out of the material holder when the lateral through hole of the inner shaft tube is switching from communicating with the first material to the second material, since the material holder is apart from the rotatable spray head.

Similarly, the outer shell and the inner shaft tube of the multi-material spraying apparatus can be made of Teflon or other materials that exhibit proper non-stick characteristics. During material spraying, the material is first delivered into the lateral through hole of the inner shaft tube from the radial inlet of the outer shell, and then the material is delivered through the central channel and ejected via the ejecting outlet of the outer shell. Therefore, the material does pass through the outer shell and the inner shaft tube during material spraying. To prevent the material from adhering to the surface of the outer shell or the inner shaft tube and in order to solve the material mixing problem, the outer shell and the inner shaft tube are preferably made of Teflon. Due to the non-stick characteristic of Teflon, materials will generally not adhere to a Teflon-made or Teflon-coated surface, and the material mixing problem can be properly solved. Furthermore, the Teflon-made outer shell and inner shaft tube have lower surface friction, such that the inner shaft tube can be rotated relative to the outer shell with ease. That is to say, a small power source is enough to drive the inner shaft tube or the outer shell in order to create a relative rotational motion therebetween.

Furthermore, the gas supplying device may comprise an air pump, a feed pipe, and a gas reservoir. The air pump is connected to the gas reservoir via the feed pipe, and the gas supplying pipe is connected to the gas reservoir. The air pump continuously pumps motive gas into the gas reservoir via the feed pipe. Then, the motive gas is delivered from the gas reservoir to the rotatable spray head via the gas supplying pipe. The gas reservoir is provided to allow the motive gas supplied to the rotatable spray head to maintain a constant flow rate and a constant pressure. If the air pump is directly connected to the rotatable spray head, the material sprayed from the rotatable spray head would be scattered or not be uniform due to the strong ejecting force during the initial stage of the spraying process; in addition, the material supplying speed (material flow rate) and the throughput could be adversely affected because of the possibility of unstable motive gas supply by the air pump. As a result, the gas reservoir is utilized to store the motive gas (air) under a certain amount and pressure, such that the motive gas can be more stably delivered to the gas supplying pipe. Furthermore, to accommodate different makeup materials, the gas reservoir allows for easier adjustment of pressure or flow rate of the motive gas.

Additionally, the multi-material spraying apparatus may further comprise a pressurizing device. The pressurizing device may further comprise at least two pressurizing pipes communicating with respective material holders. Each of the pressurizing pipes is further connected to a control valve to control the pressurization of the corresponding material holder. Without the pressurizing device, the motive gas pumped to the central channel of the inner shaft tube can still push the material in the rotatable spray head to be sprayed based on the Bernoulli principle; however with the pressurizing device, the material holder is pressurized by a certain pressure, and the material inside the material holder can be pushed out of the material holder in a much easier manner. Furthermore, besides being used for cutting on or off the pressurization, the control valves may further control the magnitude of pressurization so as to regulate the material supplying speed or to cut off the supply of material.

Furthermore, the pressurization device may further comprise a selecting device. At least two pressurizing pipes are connected to the selecting device. The selecting device is provided to selectively pressurize one of the at least two pressurizing pipes. Besides the control valves for controlling whether the material holders are pressurized or not, and the selecting device is provided to choose which material holder is to be pressurized. All of the pressurizing pipes are connected to the selecting device, such that the desired pressurizing pipe to be pressurized can be switched to by the selecting device based on the user needs. Then, the material holder is pressurized to allow the material in the material holder to be pushed into the rotatable spray head.

The instant disclosure further provides a method for spraying multiple materials. The method comprises a gas supplying step, an ejecting step and a recycling step. The gas supplying step is supplying a motive gas to a central channel of an inner shaft tube. A lateral through hole is formed on the inner shaft tube to communicate with the central channel. The ejecting step comprises pressurizing a first material holder to enable a first material in the first material holder to be delivered to a first radial inlet of an outer shell through a first material feed pipe, wherein the outer shell defines a receiving cavity therein to receive the inner shaft tube, and the first radial inlet communicates with the lateral through hole of the inner shaft tube. The first material is delivered through the lateral through hole and the central channel, and then the first material is ejected from an ejecting outlet of the outer shell. The recycling step comprises stopping the pressurization of the first material holder, enabling the first material holder to communicate with the ambient atmosphere, and continuously supplying motive gas to the central channel, so that the first material is delivered through the lateral through hole and the first radial inlet, and recycled back to the first material holder through the first material feed pipe.

The above-mentioned method for spraying multiple materials is applicable to the aforementioned multi-material spraying apparatus. In addition to the gas supplying and ejecting steps, the method also includes the recycling step. In the gas supplying step, the motive gas is first delivered to the central channel of the inner shaft tube. In the ejecting step, the first material holder is pressurized such that the first material in the first material holder is delivered to the first radial inlet through the first material feed pipe. The pressurization continues so that the first material can be further delivered through the lateral through hole and the central channel of the outer shell and ejected through the ejecting outlet of the outer shell, so that material spraying of the first material can be carried out. And then, the recycling step is done prior to the spraying of a second material.

The recycling step is provided to allow the first material that is already in the outer shell or in the inner shaft tube can be recycled back to the first material holder or the first material feed pipe. Therefore, after the recycling step, the first material is not left in the ejecting outlet of the outer shell and the central channel and the lateral through hole of the inner shaft tube. Accordingly, material mixing can be prevented when the second material is delivered to the ejecting outlet of the outer shell and the central channel and the lateral through hole of the inner shaft tube. To carry out the recycling step, the pressurization of the first material holder is first terminated, and then the first material holder is allowed to communicate with the ambient atmosphere. At this moment, motive gas is being supplied continuously to the central channel. Since the first material holder is now communicating with the ambient atmosphere, the motive gas delivered to the central channel pushes the first material in the central channel and in the lateral through hole of the inner shaft tube back to the first radial inlet of the outer shell or even back to the first material feed pipe.

Since the outer shell and the inner shaft tube are preferably made of Teflon that exhibits a non-stick characteristic, the first material does not adhere to the surfaces of the inner shaft tube and the outer shell, but instead will be pushed back toward the first material feed pipe or the first material holder by the motive gas. Therefore, since the first material originally in the outer shell and the inner shaft tube is recycled back to the first material feed pipe or the first material holder, when the second material is delivered to the outer shell and the inner shaft tube, material mixing will not occur.

Furthermore, the method for spraying multiple materials can further comprise a switching step and a re-ejecting step. The switching step comprises the controlling of relative rotational motion between the inner shaft tube and the outer shell, so that the lateral through hole of the inner shaft tube can communicate with a second radial inlet of the outer shell. The re-ejecting step comprises pressurizing a second material holder to deliver the second material therein to the second radial inlet of the outer shell through the second material feed pipe, such that the second material is delivered through the lateral through hole and the central channel and ejected from the ejecting outlet of the outer shell.

After the recycling step of the first material is carried out such that the first material is recycled back to the first material feed pipe or the first material holder, the next step is to switch to the second material holder for spraying the second material. The switching step is carried out to allow the lateral through hole of the inner shaft tube to communicate with the second radial inlet, such that the second material can be ejected by the rotatable spray head in the re-ejecting step.

After the recycling step of the first material is carried out, or after the material spraying step of the second material and the recycling step of the second material are carried out, an additional switching step and a washing step may be carried out. Similar to the preceding switching step, this additional switching step urges the lateral through hole of the inner shaft tube to be in communication with a third radial inlet of the outer shell. Then, the washing step comprises pressurizing a third material holder to enable a cleaning liquid therein to be delivered to the third radial inlet through a third material feed pipe, such that the cleaning liquid is further delivered through the lateral through hole, the central channel, and ejected from the ejecting outlet of the outer shell. Based on this, any residual material in the outer shell and the inner shaft tube can be ejected from the ejecting outlet of the outer shell for purging.

The washing step can be carried out after material spraying is performed or before the switching step, such that the outer shell and the inner shaft tube is free of residual material. On one hand, this prevents the material from drying and adhering to the outer shell and the inner shaft tube. On the other hand, the material mixing issue can be avoided.

Here, it should be noted that the material referred herein may comprise makeup materials, painting materials, and so forth. The user may use different materials freely in the rotatable spray head for putting makeup, painting on canvases, articles, masks and so forth.

Detailed description of the characteristics and the advantages of the disclosure is shown in the following embodiments, with the technical content and the implementation of the disclosure should be readily apparent to any person skilled in the art from the detailed description, and the purposes and the advantages of the disclosure should be readily understood by any person skilled in the art with reference to content, claims and drawings in the disclosure.

### BRIEF DESCRIPTION OF THE DRAWINGS

The disclosure will become more fully understood from the detailed description given herein below for illustration only, and thus not limitative of the disclosure, wherein:

FIG. 1 is a perspective view of an exemplary embodiment of a rotatable spray head according to the instant disclosure;

FIG. 2 is an exploded view of the exemplary embodiment of the rotatable spray head according to the instant disclosure;

FIG. 3 is a partial exploded view of the exemplary embodiment of the rotatable spray head according to the instant disclosure;

FIG. 4 is a lateral sectional view of the exemplary embodiment of the rotatable spray head according to the instant disclosure;

FIG. 5 is a perspective view of an exemplary embodiment of a multi-material spraying apparatus according to the instant disclosure;

FIG. 6 is a schematic perspective view showing a material container and material holders of the multi-material spraying apparatus according to the instant disclosure;

FIG. 7 is a sectional view showing a selecting device of the multi-material spraying apparatus according to the instant disclosure;

FIG. 8 is a flowchart of an exemplary embodiment of a method for spraying multiple materials according to the instant disclosure; and

FIG. 9 is a flowchart showing a cleaning procedure of the rotatable spray head after the spray of materials.

### DETAILED DESCRIPTION

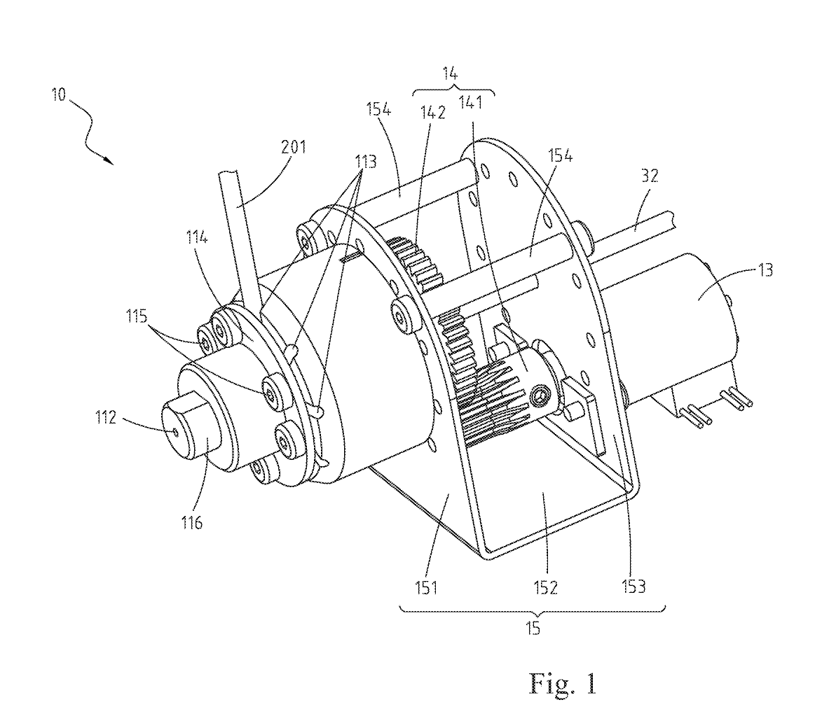

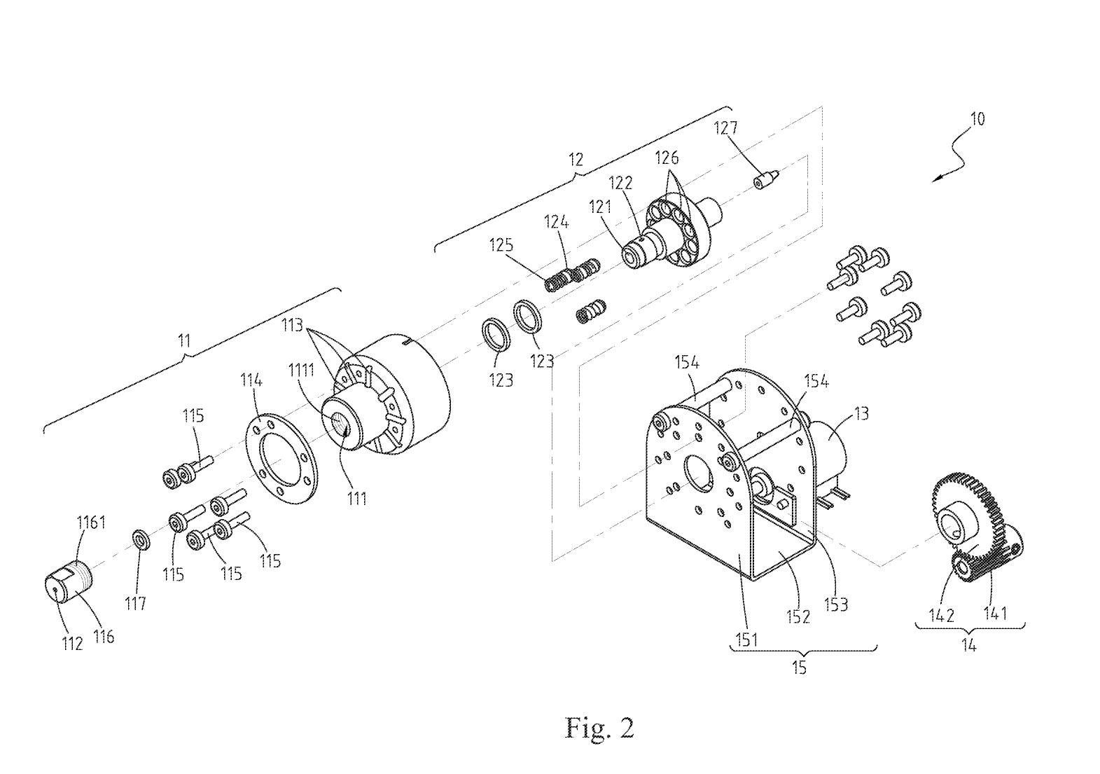

Please refer to FIG. 1 to FIG. 4, illustrating an exemplary embodiment of a rotatable spray head 10 according to the instant disclosure. The rotatable spray head 10 comprises an outer shell 11, an inner shaft tube 12, a motor 13, a speed reduction gear assembly 14 and a bracket 15. The outer shell 11 comprises an annular positioning plate 114 and defines a receiving cavity 111, an ejecting outlet 112, and nine radial inlets 113. The receiving cavity 111 communicates with the ejecting outlet 112, and the radial inlets 113 radially communicate with the receiving cavity 111. As shown in FIG. 2, in this embodiment, the outer shell 11 defines nine radial inlets 113, but is only for illustrative purpose. The number of the radial inlets 113 may be altered to increase or decrease according to the user requirements.

In this embodiment, the nine radial inlets 113 are aligned equiangularly around the longitudinal axis of the outer shell 11. That is, the nine radial inlets 113 are distantly defined around the outer shell 11, with one radial inlet 113 located every 40 degrees. The equiangular configuration allows more accurate control of the rotation by the rotatable spray head 10. However, the embodiment is not limited thereto, as in some implementation aspects, the radial inlets 113 may be non-equiangularly defined around the outer shell 11. For instance, when only two radial inlets 113 are defined around the outer shell 11, the radial inlets 113 are arranged in close proximity to each other, so that the switching of the radial inlets 113 can be performed quickly by rotating the inner shaft tube 12 or the outer shell 11 with a small rotational angle.

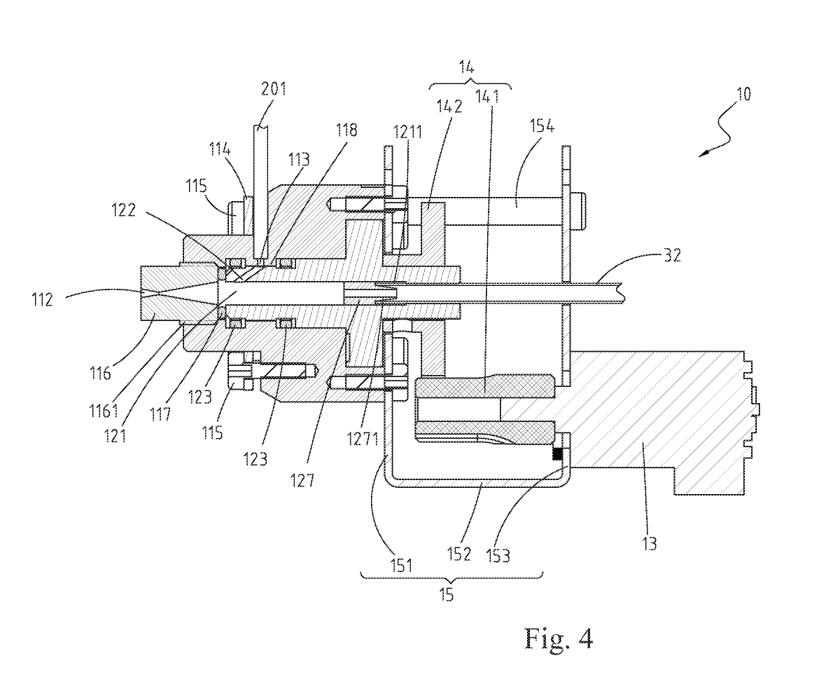

As shown in FIG. 1 and FIG. 4, at least one radial inlet 113 communicates with a material supplying pipe 201. In this embodiment, for the sake of clarity, only one material supplying pipe 201 is provided, but is not limited thereto. Each of the nine radial inlets 113 may communicate with its respective material supplying pipe 201. When installing the material supplying pipes 201, the material supplying pipes 201 are first arranged with respective radial inlets 113. Next, the positioning plate 114 is pressed against the material supplying pipes 201, for the purpose of securing the material supplying pipes 201. Then, a plurality of locking members 115 are provided to fix the annular positioning plate 114 on the outer shell 11, so that the material supplying pipes 201 are held fixedly between the positioning plate 114 and the outer shell 11.

In this embodiment, the inner surface of the receiving cavity 111 of the outer shell 11 is formed with a female thread 1111, and the outer shell 11 further comprises a nozzle 116 and a washer 117. The nozzle 116 defines the ejecting outlet 112 and has a male thread 1161. The male thread 1161 is mated with the female thread 1111, so that the nozzle 116 is locked in the receiving cavity 111 of the outer shell 11 and abutted against the washer 117. Therefore, the nozzle 116 and the inner shaft tube 12 can be in communication with each other seamlessly. Since the nozzle 116 is fixed to the outer shell 11 via screwing means, the nozzle 116 can be replaced easily after extended use or according to different spray ways to change different shapes of the nozzle.

As shown in FIG. 2 to FIG. 4, the inner shaft tube 12 is coaxially received in the receiving cavity 111 of the outer shell 11. The inner shaft tube 12 comprises a central channel 121, a lateral through hole 122, two O-rings 123, three positioning balls 124, three elastic members 125, nine positioning recesses 126, and an inserting tip 127. One of the two openings of the central channel 121 communicates with the ejecting outlet 112 of the outer shell 11, and the other opening of the central channel 121 is a gas inlet 1211. The lateral through hole 122 is defined on the inner shaft tube 12 to communicate with the central channel 121.

The inner shaft tube 12 is rotatable relative to the outer shell 11, and the lateral through hole 122 selectively communicates with one of the nine radial inlets 113. As shown in FIG. 4, the lateral through hole 122 communicates with one of the nine radial inlets 113. After the material is delivered from the material supplying pipe 201 to the radial inlet 113, the material enters the lateral through hole 122. Thereafter, the material is delivered to the central channel 121 and ejected from the ejecting outlet 112 since the lateral through hole 122 is defined on the inner shaft tube 12 and communicates with the central channel 121, and since one opening of the central channel 121 communicates with the ejecting outlet 112 of the outer shell 11. When the user wants to allow the rotatable spray head 10 to spray a different material, the inner shaft tube 12 is rotated relative to the outer shell 11 so as to allow the lateral through hole 122 to communicate with the radial inlet 113 corresponding to the different material. Consequently, different materials can be ejected from the same ejecting outlet 112.

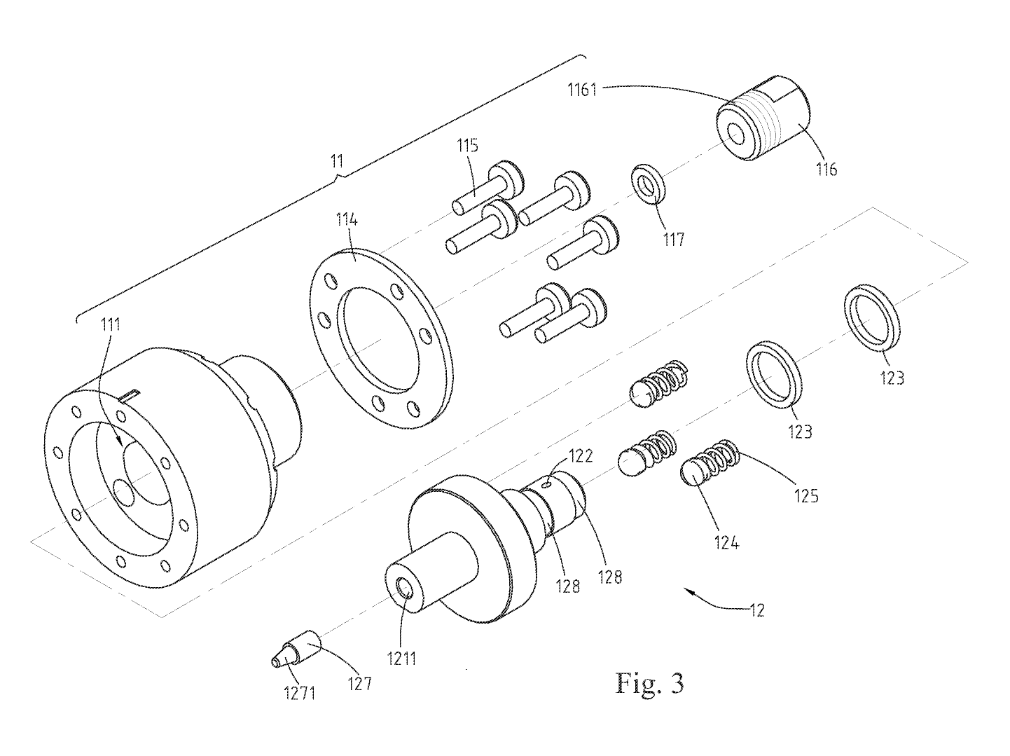

As shown in FIG. 2 and FIG. 3, the inner shaft tube 12 is formed with nine positioning recesses 126. Each of the three positioning balls 124 is abutted against one of two ends of the corresponding elastic member 125. Furthermore, the three positioning balls 124 and the three elastic members 125 are equiangularly arranged between the outer shell 11 and the inner shaft tube 12. The other end of each of the elastic members 125 is abutted against the outer shell 11, and the three positioning balls 124 are abutted against three of the nine positioning recesses 126 of the inner shaft tube 12. The three positioning balls 124 and the three elastic members 125 are provided, so that the user can hear an audible clicking sound or feel the hand tactile sensation generated from the abutments between the three elastic members 125 and the outer shell 11 and between the three positioning balls 124 and the inner shaft tube 12, to verify the inner shaft tube 12 has been properly rotated to another positioning location during the rotation of the inner shaft tube 12. In this embodiment, the rotatable spray head 10 has nine radial inlets 113, so that nine positioning recesses 126 are provided correspondingly. Meanwhile, based on the consideration of the number of elements and the positioning effectiveness, the provision of three positioning balls 124 and three elastic members 125 are sufficient for this embodiment. However, the number of the positioning balls 124 and elastic members 125 can be increased or decreased, and the number is not limited thereto.

The two O-rings 123 are fitted on the inner shaft tube 12. The lateral through hole 122 is formed on a protruded portion of the inner shaft tube 12, and the two O-rings 123 sandwich the protruded portion along an axial direction of the inner shaft tube 12. As shown in FIG. 3, two receiving portions 128 are formed on the outer wall of the inner shaft tube 12 to receive the O-rings 123. The inner wall of the receiving cavity 111 of the outer shell 11 further has a neck segment 118, and the radial inlets 113 are defined in the neck segment 118. As shown in FIG. 4, it should be noted that the inner wall of the receiving cavity 111 further defines two concaved portions for receiving the O-rings 123, with the neck segment 118 being sandwiched therebetween. The O-rings 123 are provided to facilitate the sealing between the outer shell 11 and the inner shaft tube 12.

Furthermore, the low-viscosity material is prone to enter the receiving cavity 111 of the outer shell 11 from the gap between the radial inlet 113 and the lateral through hole 122 when the material is delivered to the lateral through hole 122 from the radial inlet 113, such that the material would stick to the outer surface of the inner shaft tube 12 and the inner surface of the outer shell 11. Accordingly, it is difficult to create relative rotational motion between the outer shell 11 and the inner shaft tube 12 because of the solidified material therebetween resulting in an increase of rotational friction after extended use of the rotatable spray head 10. In addition, the cleaning of the rotatable spray head 10 requires disassembling the whole structure, which is very inconvenient. To address this issue, the two O-rings 123 are provided to specifically sandwich the protruded portion where the lateral through hole 122 is defined, such that the material flowing into the receiving cavity 111 of the outer shell 11 from the gap between the radial inlet 113 and the lateral through hole 122 can be stopped at opposite sides of the protruded portion by the blocking effect of the O-rings 123. As a result, the rotational friction between the outer shell 11 and the inner shaft tube 12 can be reduced due to fewer materials sticking to the outer shell 11 and the inner shaft tube 12. Furthermore, the rotatable spray head 10 can be cleaned much easier due to fewer residual materials.

As shown in FIG. 4, the inserting tip 127 of the inner shaft tube 12 is adapted to the gas inlet 1211 of the central channel 121. In this embodiment, the inserting tip 127 has a tapered segment 1271 extending toward the gas inlet 1211, after the inserting tip 127 is inserted into the inner shaft tube 12. When the motive gas necessary for material spraying is to be entered into the central channel 121, a gas supplying pipe 32 can be connected to the inserting tip 127. The gas supplying pipe 32 can be connected in line with the inserting tip 127 easily via the tapered segment 1271 of the inserting tip 127. Furthermore, the tapered segment 1271 of the inserting tip 127 can slightly expand the opening of the gas supplying pipe 32 when connecting therewith, so that the inserting tip 127 and the gas supplying pipe 32 can be more firmly engaged to each other. Based on this, the gas supplying pipe 32 would not easily detach from the inserting tip 127 under the influence of backward counterforce produced when supplying the motive gas.

In this embodiment, the bracket 15 is U-shaped. The bracket 15 comprises an abutting plate 151, a bottom plate 152, a supporting plate 153 and two supporting members 154. The abutting plate 151 and the supporting plate 153 are arranged in a parallel manner, and two sides of the bottom plate 152 are respectively connected to the abutting plate 151 and the supporting plate 153, such that the abutting plate 151, the supporting plate 153, and the bottom plate 152 form the U-shaped bracket. In order to maintain the parallel arrangement between the abutting plate 151 and the supporting plate 153, the two supporting members 154 are applied away from the bottom plate 152 to lock the abutting plate 151 with the supporting plate 153. After the inner shaft tube 12 is received in the receiving cavity 111 of the outer shell 11, the bracket 15 is then locked to the outer shell 11. Therefore, the inner shaft tube 12 can be firmly received in the receiving cavity 111 of the outer shell 11 by the abutment of the abutting plate 151, such that the inner shaft tube 12 would not detach from the outer shell 11 under the influence of backward counterforce produced when the motive gas is being supplied from the gas supplying pipe 32 to the central channel 121.

The motor 13 is fixed to the supporting plate 153. The speed reduction gear assembly 14 is connected between the motor 13 and the inner shaft tube 12. The motor 13 drives the inner shaft tube 12 to rotate via the speed reduction gear assembly 14. In this embodiment, the speed reduction gear assembly 14 comprises a first speed reduction gear 141 and a second speed reduction gear 142. The first speed reduction gear 141 and the second speed reduction gear 142 are engaged with each other. The first speed reduction gear 141 is connected to the motor 13, and the second speed reduction gear 142 is connected to the inner shaft tube 12. Accordingly, the rotational speed of the inner shaft tube 12 driven by the motor 13 can be adjusted by the speed reduction gear assembly 14.

It should be understood that in this embodiment, the outer shell 11, the inner shaft tube 12 and the inserting tip 127 are all made of Teflon. During material spraying, the material is first delivered into the lateral through hole 122 of the inner shaft tube 12 from one of the radial inlets 113 of the outer shell 11, and then the material is delivered through the central channel 121 and ejected from the ejecting outlet 112 of the outer shell 11. Therefore, the material passes through the outer shell 11 and the inner shaft tube 12 during material spraying. To prevent the material from adhering to the surface of the outer shell 11 or the inner shaft tube 12 and to solve the material mixing problem, the outer shell 11 and the inner shaft tube 12 are preferably made of Teflon. Due to the non-stick characteristic of Teflon, materials will generally not adhere to a Teflon-made or Teflon-coated surface, and the material mixing problem can be prevented.

Furthermore, the Teflon-made outer shell 11, inner shaft tube 12 and inserting tip 127 have lower surface frictions, such that the inner shaft tube 12 can be rotated relative to the outer shell 11 easily. Namely, when the outer shell 11, the inner shaft tube 12 and the inserting tip 127 are all made of Teflon, a small power source (for example, the motor 13) is sufficient for driving the outer shell or the inner shaft tube 12 to generate the rotational motion. Furthermore, since the friction between the inner shaft tube 12 and the inserting tip 127 is quite small, the inserting tip 127 is not rotated during the rotation of the inner shaft tube 12, such that the gas supplying pipe 32 connected to the inserting tip 127 is not twisted when the inner shaft tube 12 is rotated relative to the outer shell 11.

Accordingly, the materials placed in different material holders can be delivered into the central channel 121 of the inner shaft tube 12 of the rotatable spray head 10 via different radial inlets 113 and then ejected via the ejecting outlet 112 of the outer shell 11. When the user wants to switch the spraying material, the inner shaft tube 12 is rotated relative to the outer shell 11 until the through hole 122 is aligned to and communicates with the radial inlet 113 of the material to be sprayed. Based on this, different materials can be sprayed from the same ejecting outlet 112.

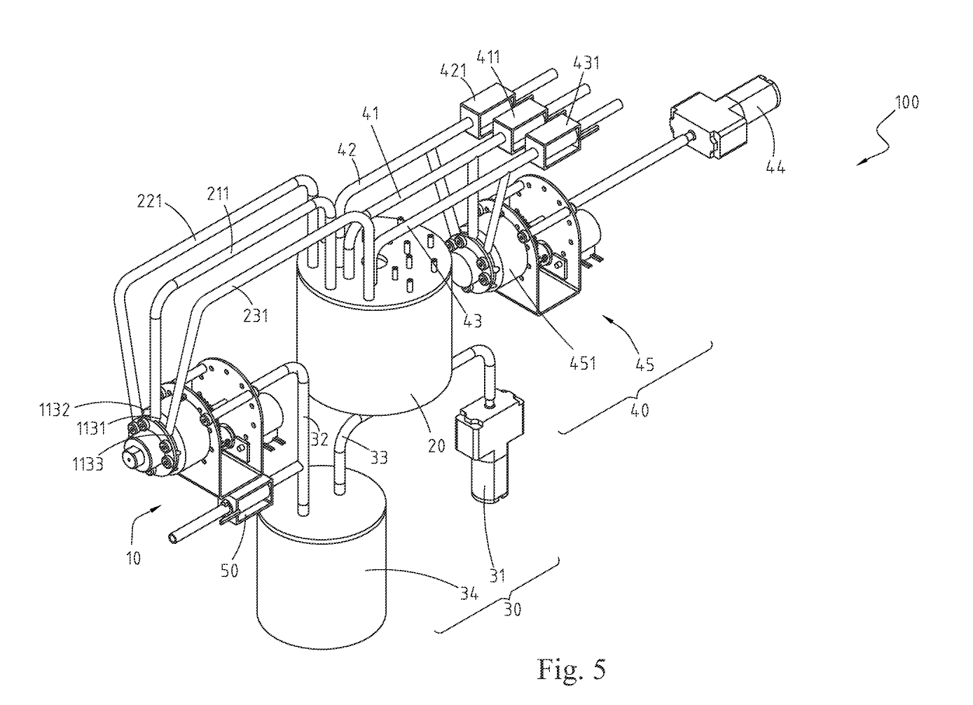

Please refer to FIG. 5 to FIG. 7, which provide a perspective view of an exemplary embodiment of a multi-material spraying apparatus, a schematic perspective view showing a material container and material holders of the multi-material spraying apparatus, and a sectional view showing a selecting device of the multi-material spraying apparatus. These figures illustrate a multi-material spraying apparatus 100, a material container 20, and a selecting device 45, respectively, according to the instant disclosure. The multi-material spraying apparatus 100 comprises the rotatable spray head 10, nine material holders, a gas supplying device 30, and a pressurizing device 40. It is understood that the structure of the rotatable spray head 10 mentioned herein is already described in the preceding paragraphs and is labeled with the same reference numerals, and thus, no further elaboration will be provided.

In this embodiment, since the rotatable spray 10 may be connected to at most nine material supplying pipes, the multi-material spraying apparatus 100 comprises a material container 20 that includes nine material holders. However, the embodiments are not limited thereto, as the number of the material holders can be changed based on the number of the material supplying pipes or according to user requirements.

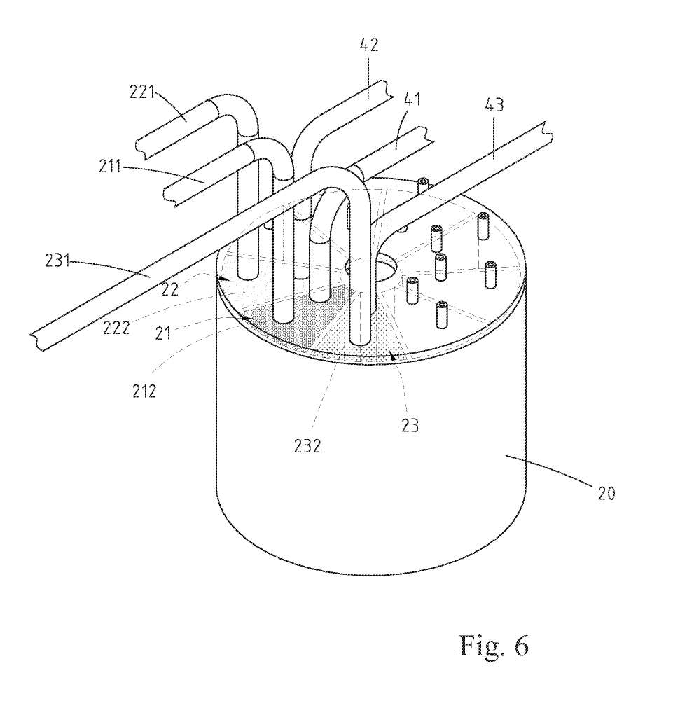

As shown in FIG. 5, one material supplying pipe is extended from each of the material holders and communicates with one corresponding radial inlet 113 of the outer shell 11. In this embodiment, for the sake of clarity, three material holders (that is, a first material holder 21, a second material holder 22 and a third material holder 23), are illustrated. With reference to FIG. 6, the material container 20 may be divided into nine material holders. The first material holder 21 is connected to a first material feed pipe 211, the second material holder 22 is connected to a second material feed pipe 221, and the third material holder 23 is connected to a third material feed pipe 231. The first material feed pipe 211, the second material feed pipe 221, and the third material feed pipe 231 are connected to respective radial inlets 113 of the outer shell 11.

The pressurizing device 40 may comprise a pressurizing pump 44, the selecting device 45 and nine pressurizing pipes. Each of the pressurizing pipes is further connected to a control valve for pressurizing or not pressuring the corresponding material holder. In this embodiment, the material container 20 of the multi-material spraying apparatus 100 comprises three material holders, thus the pressurizing device 40 comprises three pressurizing pipes. However, the number of the pressurizing pipes may be adjusted according to user requirements. In this embodiment, the first pressurizing pipe 41, the second pressurizing pipe 42, and the third pressurizing pipe 43 communicate with the first material holder 21, the second material holder 22, and the third material holder 23, respectively. Meanwhile, a first control valve 411 is connected to a first pressurizing pipe 41, a second control valve 421 is connected to a second pressurizing pipe 42, and a third control valve 431 is connected to a third pressurizing pipe 43.

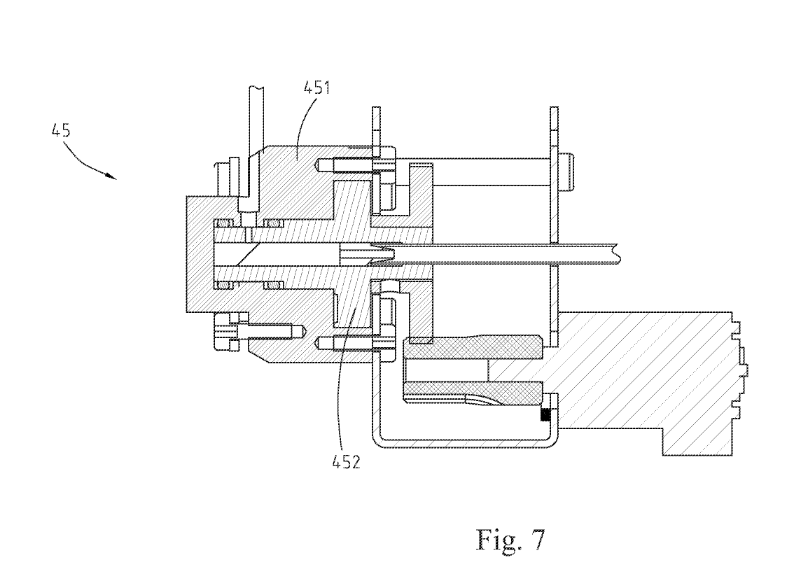

The pressurizing pump 44 is connected to the selecting device 45 so as to pressurize one of the three pressurizing pipes (that is, one of the first pressurizing pipe 41, the second pressurizing pipe 42 and the third pressurizing pipe 43). The structure of the selecting device 45 may be similar to that of the rotatable spray head 10. Please refer to FIG. 7, in which the selecting device 45 comprises an outer shell 451 and an inner shaft tube 452. The selecting device 45 is structurally similar to the rotatable spray head 10 except the outer shell 451 is devoid of an ejecting outlet. The selecting device 45 is provided to allow the gas from the pressurizing pump 44 to pressurize one of the pressurizing pipes. Therefore, since the gas from the pressurizing pump 44 only enters into the corresponding pressurizing pipe, the outer shell 451 of the selecting device 45 does not require the ejecting outlet.

Please refer to FIG. 5, in which the gas supplying device 30 comprises an air pump 31, a gas supplying pipe 32, a feed pipe 33 and a gas reservoir 34. The air pump 31 is connected to the gas reservoir 34 via the feed pipe 33. One of two ends of the gas supplying pipe 32 is connected to the gas reservoir 34, and the other end thereof communicates with the gas inlet 1211 of the inner shaft tube 12 of the rotatable spray head 10. The gas supplying pipe 32 is further connected to an electromagnetic valve 50. The electromagnetic valve 50 controls the gas supplying pipe 32 to control the supply of the motive gas to the gas inlet 1211. In this embodiment, the air pump 31 of the gas supplying device 30 does not supply the motive gas to the gas supplying pipe 32 directly; instead, the motive gas is first pumped into the gas reservoir 34 then delivered to the gas supplying pipe 32. The gas reservoir 34 is provided to allow the motive gas supplied to the rotatable spray head 10 to maintain a constant flow rate and pressure. If the air pump 31 is directly connected to the rotatable spray head 10, the material sprayed from the rotatable spray head 10 would be scattered or not uniform due to the strong ejecting force during the initial stage of material spraying; in addition, the material supplying speed (material flow rate) and the throughput could be adversely affected because of the possibility of unstable motive gas supply by the air pump 31. As a result, the gas reservoir 34 is utilized to store a certain amount of the motive gas under certain pressure, such that the motive gas can be more stably delivered to the gas supplying pipe 32. Furthermore, via the reservoir 34, the pressure or the flow rate of the motive gas provided to the rotatable spray head 10 can be adjusted more easily if necessary.

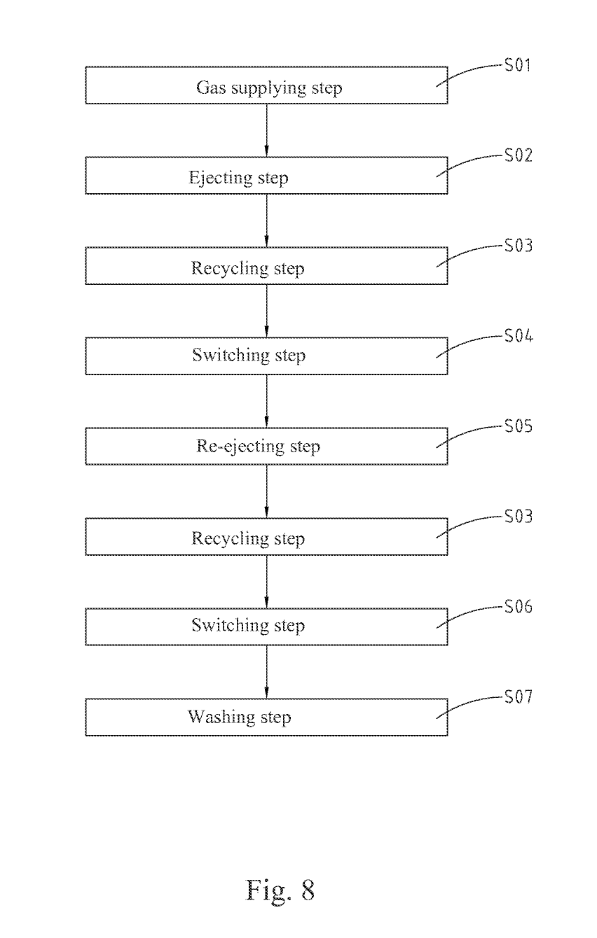

Please refer to FIG. 1 to FIG. 8. FIG. 8 illustrates a flowchart of an exemplary embodiment of a method for spraying multiple materials according to the instant disclosure. In this embodiment, an exemplary embodiment of the method for spraying multiple materials is demonstrated by the aforementioned multi-material spraying apparatus 100. The method for spraying multiple materials comprises a gas supplying step S01, an ejecting step S02, a recycling step S03, a switching step S04 and a re-ejecting step S05. The gas supplying step S01 comprises supplying the motive gas to the central channel 121 of the inner shaft tube 12. In detail, first, the electromagnetic valve 50 is turned off and the gas supplying device 30 is turned on, so that the air is continuously pressurized and delivered to the central channel 121 of the rotatable spray head 10. Furthermore, before the gas supplying step S01, the pressurizing pump 44 can be activated in advance to pressurize the first pressurizing pipe 41 in order to allow air be delivered into the first material holder 21, such that the first material 212 is mixed with air in advance. Since particle precipitation or oil/pigment separation might occur when the material is stored in the material holder after a period of time, the premixing step allows air to be pumped into the material holder to stir and mix the material before spraying.

The ejecting step S02 comprises pressurizing the first material holder 21 to enable the first material 212 therein to be delivered to a first radial inlet 1131 of the outer shell 11 through the first material feed pipe 211, and then, the first material 212 is delivered through the lateral through hole 122 and the central channel 121 and ejected from the ejecting outlet 112 of the outer shell 11. In detail, the pressurizing device 40 is activated to pressurize and deliver the air to the first material holder 21 continuously, such that the first material 212 in the first material holder 21 is delivered to the first radial inlet 1131 of the outer shell 11 along the first material feed pipe 211. Then, the first material 212 is further delivered through the lateral through hole 122 and the central channel 121 and ejected from the ejecting outlet 112 of the outer shell 11.

When the user wants to change the material to be sprayed from the first material 212 to a second material 222, the recycling step S03 is carried out in advance. The recycling step S03 is provided to allow the first material 212 that is already in the outer shell 11 and the inner shaft tube 12 to be recycled back to the first material holder 21 or the first material feed pipe 211. Therefore, after the recycling step S03, the first material 212 is not left in the ejecting outlet 112 of the outer shell 11 and in the central channel 121 and the lateral through hole 122 of the inner shaft tube 12. Accordingly, material mixing can be prevented when the second material 222 is delivered to the ejecting outlet 112 of the outer shell 11 and to the central channel 121 and the lateral through hole 122 of the inner shaft tube 12.

The recycling step S03 comprises stopping the pressurization of the first material holder 21, enabling the first material holder 21 to communicate with the ambient atmosphere, and continuously supplying the motive gas to the central channel 121, so that the first material 212 is delivered through the lateral through hole 122 and the first radial inlet 1131 and recycled back to the first material holder 21 through the first material feed pipe 211. In this embodiment, first the pressurization of the first material holder 21 is terminated, and then the first material holder 21 is allowed to communicate with the ambient atmosphere. At this moment, the motive gas is being supplied continuously to the central channel 121. Since the first material holder 21 is now communicating with the ambient atmosphere, the motive gas delivered to the central channel 121 pushes the first material 212 in the central channel 121 and in the lateral through hole 122 of the inner shaft tube 12 back to the first radial inlet 1131 of the outer shell 11, or even back to the first material feed pipe 211. The communication between the first material holder 21 and the ambient atmosphere can be carried out by controlling and opening the first control valve 411 connected to the first pressurizing pipe 41.

As mentioned before, since the outer shell 11 and the inner shaft 12 tube are preferably made of Teflon having a non-stick characteristic, the first material 212 does not adhere to the surfaces of the inner shaft tube 12 or the outer shell 11, but instead will be pushed back toward the first material feed pipe 211 or the first material holder 21 by the motive gas. Therefore, since the first material 212 originally in the outer shell 11 and the inner shaft tube 12 is recycled back to the first material feed pipe 211 or the first material holder 21, when the second material 222 is delivered to the outer shell 11 and the inner shaft tube 12, material mixing issue will not occur.

Next, the switching step S04 is carried out if the second material 222 is going to be sprayed. The switching step S04 comprises controlling the inner shaft tube 12 to rotate relative to the outer shell 11 or controlling the outer shell 11 to rotate relative to the inner shaft tube 12, so that the lateral through hole 122 of the inner shaft tube 12 can communicate with a second radial inlet 1132 of the outer shell 11. In this embodiment, the motor 13 and the speed reduction gear assembly 14 are utilized to control the rotation of the inner shaft tube 12 relative to the outer shell 11, such that the lateral through hole 122 of the inner shaft tube 12 communicates with the second radial inlet 1132 of the outer shell 11. Then, the re-ejecting step S05 is carried out so as to spray the second material 222. The re-ejecting step S05 comprises pressurizing the second material holder 22 to deliver the second material 222 therein to the second radial inlet 1132 of the outer shell 11 through the second material feed pipe 221, such that the second material 222 is delivered through the lateral through hole 122 and the central channel 121 and ejected from the ejecting outlet 112 of the outer shell 11.

In this embodiment, after the material spraying of the first material 212 is accomplished, the material to be sprayed is switched to the second material 222, but is not limited thereto. The aforementioned steps can be repeated to spray multiple materials from the same ejecting outlet 112 free of material mixing issue.

After the material spray of the second material 222 is accomplished and the recycling step S03 of the second material 222 is carried out, a cleaning procedure can be done to clean the outer shell 11 and the inner shaft tube 12, as shown in FIG. 8. The cleaning procedure comprises a switching step S06 and a washing step S07. The switching step S06 comprises controlling the inner shaft tube 12 to rotate relative to the outer shell 11 or controlling the outer shell 11 to rotate relative to the inner shaft tube 12, so that the lateral through hole 122 of the inner shaft tube 12 communicates with a third radial inlet 1133 of the outer shell 11.

The washing step S07 comprises pressurizing a third material holder 23 to enable a cleaning liquid 232 therein to be delivered to the third radial inlet 1133 through the third material feed pipe 231, such that the cleaning liquid 232 is delivered through the lateral through hole 122 and the central channel 121, and ejected from the ejecting outlet 112 of the outer shell 11. Based on this, any residual material left in the outer shell 11 and the inner shaft tube 12 can be ejected from the ejecting outlet 112 of the outer shell 11 for purging. The washing step S07 can be carried out after material spraying is performed or before the switching step S04, such that the outer shell 11 and the inner shaft tube 12 is free of residual material, and the material mixing issue can be avoided.

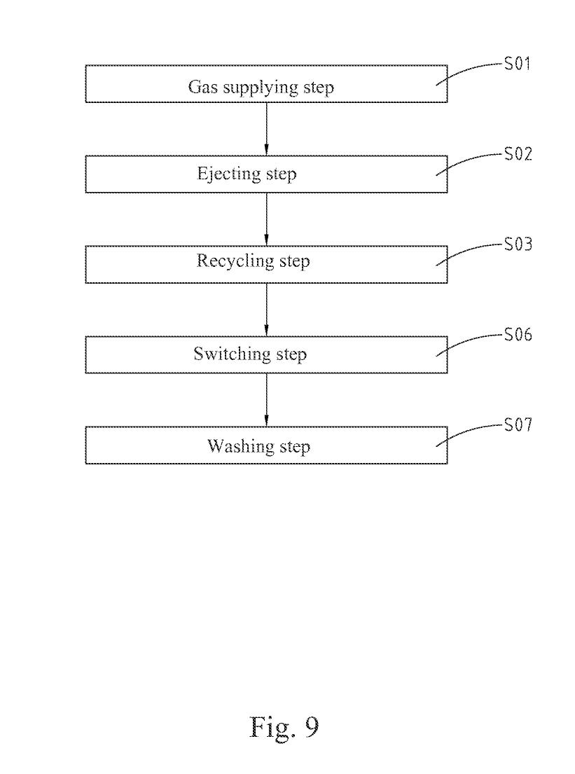

As mentioned in the above, the cleaning procedure may be carried out after the material spraying of the first material 212 and the second material 222 is accomplished, or may be carried out every time the material spraying is accomplished. FIG. 9 illustrates a flowchart showing the cleaning procedure of the rotatable spray head 10 after material spraying. After the material spraying of the first material 212 is accomplished, (namely, after the gas supplying step S01, the ejecting step S02, and the recycling step S03 are carried out), the switching step S06 and the washing step S07 are then carried out to clean the outer shell 11 and the inner shaft tube 12. Thereafter, the material spraying of the second material 222 is to be carried out. Accordingly, the material mixing problem can be prevented.

Here, the materials referred to in the description may be makeup materials, painting materials, and so forth. The user may use different materials freely for different purposes in the rotatable spray head for putting makeup, painting on canvas, articles, masks and so forth.

While the disclosure has been described by way of examples and in terms of preferred embodiments, it is to be understood that the invention is not limited to the disclosed embodiments. On the contrary, the intent is to cover various modifications and similar arrangements, which are within the spirit and scope of the appended claims, the scope of which should be accorded the broadest interpretation so as to encompass all such modifications and similar structures.

What is claimed is:

1. A rotatable spray head, comprising:
an outer shell, defining a receiving cavity, an ejecting outlet and at least two radial inlets, wherein the receiving cavity communicates with the ejecting outlet and the radial inlets radially communicate with the receiving cavity; and
an inner shaft tube, coaxially received in the receiving cavity, wherein the inner shaft tube defines a central channel and a lateral through hole, one of two openings of the central channel communicates with the ejecting outlet of the outer shell, and the other opening of the central channel is a gas inlet, the lateral through hole is defined on the inner shaft tube and communicates with the central channel;
wherein the inner shaft tube is rotatable relative to the outer shell, and the lateral through hole selectively communicates with one of the radial inlets.

2. The rotatable spray head according to claim 1, wherein the outer shell and the inner shaft tube are made of Teflon.

3. The rotatable spray head according to claim 1, further comprising:
a motor; and
a speed reduction gear assembly, connected between the motor and the inner shaft tube, wherein the motor drives the inner shaft tube to rotate via the speed reduction gear assembly.

4. The rotatable spray head according to claim 1, further comprising two O-rings fitted on the inner shaft tube, wherein the lateral through hole is formed on a protruded portion of the inner shaft tube, and the two O-rings sandwich the protruded portion along an axial direction of the inner shaft tube.

5. The rotatable spray head according to claim 1, wherein the radial inlets are aligned equiangularly around the longitudinal axis of the outer shell.

6. The rotatable spray head according to claim 1, wherein the inner wall of the receiving cavity of the outer shell further has a neck segment, and the radial inlets are defined in the neck segment.

7. The rotatable spray head according to claim 1, further comprising an abutting plate locked with the outer shell and abutted against the inner shaft tube.

8. The rotatable spray head according to claim 1, wherein an inner wall of the receiving cavity is formed with female threads and the outer shell further includes a nozzle, wherein the nozzle defines the ejecting outlet and forms with male threads, and wherein the male threads are engaged with the female threads for retaining the nozzle in the receiving cavity.

9. The rotatable spray head according to claim 1, wherein the inner shaft tube further comprises an inserting tip adapted to the gas inlet of the central channel.

10. A multi-material spraying apparatus, comprising
a rotatable spray head, comprising an outer shell and an inner shaft tube, wherein the outer shell defines a receiving cavity, an ejecting outlet and at least two radial inlets, wherein the receiving cavity communicates with the ejecting outlet, the radial inlets communicate with the receiving cavity, wherein the inner shaft tube is coaxially received in the receiving cavity, the inner shaft tube defines a central channel and a lateral through hole, wherein one of two openings of the central channel communicates with the ejecting outlet of the outer shell, and the other opening of the central channel is a gas inlet, wherein the lateral through hole is defined on the inner shaft tube and communicates with the central channel, wherein the inner shaft tube is rotatable relative to the outer shell, and the lateral through hole selectively communicates with one of the radial inlets;
at least two material holders, wherein a material supplying pipe is extended from each of the material holders to communicate with the corresponding radial inlet of the outer shell; and
a gas supplying device, comprising a gas supplying pipe communicating with the gas inlet of the inner shaft tube, wherein an electromagnetic valve is coupled to the gas supplying pipe to control the motive gas supply to the gas inlet.

11. The multi-material spraying apparatus according to claim 10, wherein the outer shell and the inner shaft tube are made of Teflon.

12. The multi-material spraying apparatus according to claim 10, wherein the gas supplying device comprises an air pump, a feed pipe and a gas reservoir, the air pump is connected to the gas reservoir via the feed pipe, and the gas supplying pipe is connected to the gas reservoir.

13. The multi-material spraying apparatus according to claim 10, further comprising a pressurizing device, wherein the pressurizing device further comprises at least two pressurizing pipes communicating with respective material holders, and wherein each of the pressurizing pipes is further connected to a control valve to control the pressurization of the corresponding material holder.

14. The multi-material spraying apparatus according to claim 13, wherein the pressurizing device further comprises a selecting device, wherein the pressurizing pipes communicate with the selecting device, and wherein the selecting device selectively pressurizes one of the pressurizing pipes.

15. A method for spraying multiple materials, comprising:
supplying a motive gas to a central channel of an inner shaft tube, wherein the inner shaft tube defines a lateral through hole in communication with the central channel;
pressurizing a first material holder to enable a first material therein to be delivered to a first radial inlet of an outer shell through a first material feed pipe, wherein the outer shell defines a receiving cavity to receive the inner shaft tube, the first radial inlet communicates with the lateral through hole of the inner shaft tube, the first material is delivered through the lateral through hole and the central channel, and the first material is ejected from an ejecting outlet of the outer shell; and
stopping pressurization of the first material holder and establishing communication between the first material holder and the ambient atmosphere and continuously supplying the motive gas to the central channel for urging the first material through the lateral through hole, the first radial inlet, and the first material feed pipe in sequence for recycling the first material back to the first material holder.

16. The method for spraying multiple materials according to claim 15, wherein the outer shell and the inner shaft tube are made of Teflon.

17. The method for spraying multiple materials according to claim 15, further comprising:
controlling the inner shaft tube to rotate relative to the outer shell or the outer shell to rotate relative to the inner shaft tube, so that the lateral through hole of the inner shaft tube communicates with a third radial inlet of the outer shell; and
pressurizing a third material holder to enable a cleaning liquid therein to be delivered to the third radial inlet through a third material feed pipe for urging the cleaning liquid through the lateral through hole and the central channel and ejecting the cleaning liquid is from the ejecting outlet of the outer shell.

18. The method for spraying multiple materials according to claim 15, further comprising:
controlling the inner shaft tube to rotate relative to the outer shell or controlling the outer shell to rotate relative to the inner shaft tube, so that the lateral through hole of the inner shaft tube communicates with a second radial inlet of the outer shell; and
pressurizing a second material holder to deliver a second material therein to the second radial inlet of the outer shell through a second material feed pipe for urging the second material through the lateral through hole and the central channel and ejecting the second material from the ejecting outlet of the outer shell.

19. The method for spraying multiple materials according to claim 18, further comprising:
controlling the inner shaft tube to rotate relative to the outer shell or controlling the outer shell to rotate relative to the inner shaft tube, so that the lateral through hole of the inner shaft tube communicates with a third radial inlet of the outer shell; and
pressurizing a third material holder to enable a cleaning liquid therein to be delivered to the third radial inlet through a third material feed pipe for urging the cleaning liquid through the lateral through hole and the central channel and ejecting the cleaning liquid from the ejecting outlet of the outer shell.

20. The method for spraying multiple materials according to claim 15, wherein the first material is a cosmetic material.
